(19) United States
(12) Patent Application Publication
(10) Pub. No.: US 2003/0107826 A1
(43) Pub. Date: Jun. 12, 2003

(54) Mirror system for improving a motorist's field of vision

(75) Inventors: Moshe Shafrir, Jerusalem (IL); Tal Dai, Petach-Tikva (IL)

Correspondence Address: BROWDY AND NEIMARK, P.L.L.C., 624 NINTH STREET, NW, SUITE 300, WASHINGTON, DC, 20001-5303, US

(73) Assignee: PROLOG LTD., Yehud (IL)

(21) Appl. No.: 10/007,695

(22) Filed: Dec. 10, 2001

(51) Int. Cl. G02B 5/08; G02B 7/18; G02B 7/182

(52) U.S. Cl. 359/841; 359/850; 248/900

(57) ABSTRACT

A mirror system for improving a motorist's field of vision, and comprising at least one mirror having a convex reflecting surface, and a housing capable of being mounted beneath an exterior surface of a vehicle for accommodating therein the at least one mirror when not in use. A mechanism within the housing elevates the at least one mirror out of the housing through an opening in the exterior surface of the vehicle and rotates the at least one mirror after its elevation through the opening into a line of sight of the motorist thus allowing a cross-section of the opening to have a smaller area than a cross-section of the at least one mirror. After use, the mechanism retracts the mirror(s) into the housing, preferably automatically under control of a controller.

### FIELD OF THE INVENTION

This invention relates to mirrors and in particular to the use thereof for improving a motorist's vision when encountering blind spots.

### BACKGROUND OF THE INVENTION

One of the most dangerous maneuvers undertaken by a motorist relates to progressing into an area where visibility is impaired. This applies particularly when entering a junction or reversing, and when the motorist's field of view is partially occluded by an object such as a stationary vehicle.

By way of explanation, FIG. 1 shows a vehicle 10 attempting to pass a stationary vehicle 11 parked at the side of the road, in order to turn left at a junction 12 into the path of an oncoming vehicle 13. FIG. 2 shows a vehicle 20 reversing out of a parking lot 21 across a sidewalk between pedestrians 22 and 23 into the path of an oncoming vehicle 24. In both cases, the driver's line of sight is at least partially obscured during this maneuver, requiring him to edge out into the junction, possibly into the path of an oncoming vehicle and thus without knowing for sure and in advance whether, in fact, there is such a risk of collision.

FIG. 3 shows the situation depicted in FIG. 1 wherein a motorist 30 in a vehicle 31 attempts to enter a junction 32 having to pass a parked vehicle 33 and thereby entering into the path of an oncoming vehicle 34. It is seen from this figure that until the vehicle 34 becomes within the motorist's line of sight 35, the vehicle 31 has already projected from the junction into the path of the oncoming vehicle 34.

U.S. Pat. No. 5,424,875 (Davis, II) entitled “Motor vehicle safety mirror” issued Jun. 13, 1995 discloses a mirror arrangement for mounting on a motor vehicle having a passenger compartment. The mirror arrangement includes a polygonal three dimensional member having at least two planar surfaces oriented obliquely with respect to one another and intersecting one another at an apex, at least two mirrored surfaces, one each of the at least two mirrored surfaces being disposed on one each of the at least two planar surfaces. The apex is oriented substantially toward the passenger compartment of the motor vehicle and a mechanical adjustment mechanism including a rotatable support shaft connected to the polygonal three-dimensional member, and a coaxial cable connected to the rotatable support shaft rotates the directional orientation of the apex. The coaxial cable extends into the passenger compartment of the motor vehicle, and a mechanical mounting mechanism is provided for mounting the mirror arrangement on the front or rear of the motor vehicle.

The mounting mechanism fixes the mirror arrangement to an outer surface of the vehicle and so is constantly visible. Consequently, such an arrangement may be suitable for commercial vehicles but is less so for private vehicles, where esthetics are important, since the casing of the mounting mechanism is an eyesore. Moreover, each pair of facet surfaces of the apex has a predetermined and distinct angular inclination with respect to a line bisecting the apex. Multiple planar surfaces are provided on each side of the polygonal structure in order that each of the planar reflecting surfaces may present a slightly different view to the motorist, thus allowing the motorist to see over a wider field of view. However, it is conjectured that the multiple images interfere with one another and it would clearly be preferable to provide a unitary panoramic image to the motorist. Moreover, mounting such an arrangement externally on a fender or in front of the front edge of the vehicle detracts from the safety of the vehicle. Specifically, safety standards require that collision with a pedestrian at low speeds should cause minimal damage to the pedestrian. To this end the external surfaces of vehicles are designed to absorb impact and to present no sharp surfaces. Thus, mounting such a solid mirror arrangement having sharp surfaces that permanently project from an external surface of the vehicle near an extremity thereof, militates against the safety requirements. Furthermore, such sharp surfaces reduce the dynamic performance of the vehicle and cause high wind noise, particularly when traveling at high speed.

U.S. Pat. No. 4,469,405 (Wun, Su C.) entitled “Back view mirror assembly” issued Sep. 4, 1984 discloses a back view mirror assembly comprising a first casing mounted on the rear top of a vehicle body and a convex mirror for reflecting the back view of the vehicle. The convex mirror is movably mounted in the first casing and capable of extending longitudinally out of the first casing and beyond the rear top end of the vehicle body so that the reflection from the convex mirror can enable the driver to see the back view. By such means, the convex mirror can be stowed when not in use and can be extended outward when in use. Alternatively, the assembly may comprise two casings, one being at the rear top end and other being at the front top end of the vehicle body. A mirror is further provided in the front casing for reflecting the rays emerging from the convex mirror.

Such an arrangement serves as an aid to the motorist during parking and similar maneuvers and operates as a kind of periscope for allowing the motorist to see behind the vehicle for a limited field of vision, extending over only several meters. This allows the motorist to avoid collisions with pedestrians close to the rear of the vehicle and with stationary objects, such as parked vehicles. Such an arrangement is not directed to solving the problem to which the invention is directed, namely improving the motorist's field of vision when negotiating junctions and the like. Moreover, the mirror assembly is projected out of the casing when required, but the casing itself, being mounted on the roof of the vehicle, is constantly visible. Consequently, such an arrangement may be suitable for commercial vehicles but is less so for private vehicles, where esthetics and aerodynamic design are important, since the roof-mounted casing breaks the streamlines of the vehicle and is an eyesore.

U.S. Pat. No. 3,610,739 (Seashore; Carl G) entitled “Rear vision mirror system” issued Oct. 5, 1971 discloses a rear vision mirror system for passenger cars and/or road vehicles having an interior plane mirror and a fender mirror mounted on each of the forward fenders of the passenger car utilizing the system. The fender mounted mirrors are convex and have a pre-selected radius of curvature, vertical and horizontal dimensions in conjunction with a mounting technique relative to the passenger car size so that the inside vertical edge of each convex mirror reflects a field of view having an inner boundary terminating in a vertical plane that is coextensive with the rearmost visible side of the respective passenger car. To insure this inner boundary, the mirrors are preset for each vehicle and movable only in vertical plane and within the median fore and aft field of view. The interior plane mirror is to be focused, by markings, with respect to the rear window of the passenger car and has a field of view that intersects with the available field of view of left and right convex fender mounted mirrors thereby eliminating blind areas either directly behind the host passenger car or in adjacent traffic lanes. Such an arrangement is not directed to solving the problem to which the invention is directed, namely improving a motorist's field of vision when negotiating junctions and the like.

In all of these arrangements, the mirror assembly itself is a fixed unit. Thus, in U.S. Pat. No. 4,469,405, while the convex mirror may be extended out of and retracted into the casing, once extended it provides a constant and invariable field of view to the motorist. Likewise, in U.S. Pat. No. 3,610,739 the mirrors are preset for each vehicle and movable only in vertical plane and within the median fore and aft field of view. In U.S. Pat. No. 5,424,875, the mirror arrangement includes at least two mirrored surfaces oriented obliquely with respect to one another and intersecting one another at an apex. The apex angle is fixed and incapable of adjustment.

It would therefore be desirable to provide a mirror assembly for improving a motorist's field of vision when negotiating junctions and the like where not only are the mirrors retractable when not in use, but where the whole of the assembly is stowed out of sight, so that an external appearance of the vehicle is unaffected. It would further be desirable to provide such an assembly having a pair of mirrors whose angular orientation may be adjusted so as to alter their field of view, thereby allowing a motorist to direct the mirrors for optimum visibility.

### SUMMARY OF THE INVENTION

It is therefore an object of the invention to provide a mirror assembly for mounting in association with a vehicle so as to improve a motorist's field of vision, where the drawbacks associated with hitherto proposed arrangements are reduced.

To this end there is provided in accordance with a broad aspect of the invention a mirror system for improving a motorist's field of vision, said mirror system comprising:

at least one mirror having a convex reflecting surface,

a housing capable of being mounted beneath an exterior surface of a vehicle for accommodating therein said at least one mirror when not in use, and

a mechanism for elevating the at least one mirror out of the housing through an opening in the exterior surface of the vehicle and for rotating the at least one mirror after its elevation through said opening into a line of sight of the motorist thus allowing a cross-section of the opening to have a smaller area than a cross-section of the at least one mirror.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1 to 3 shows pictorially two scenarios giving rise to a motorist having impaired vision;

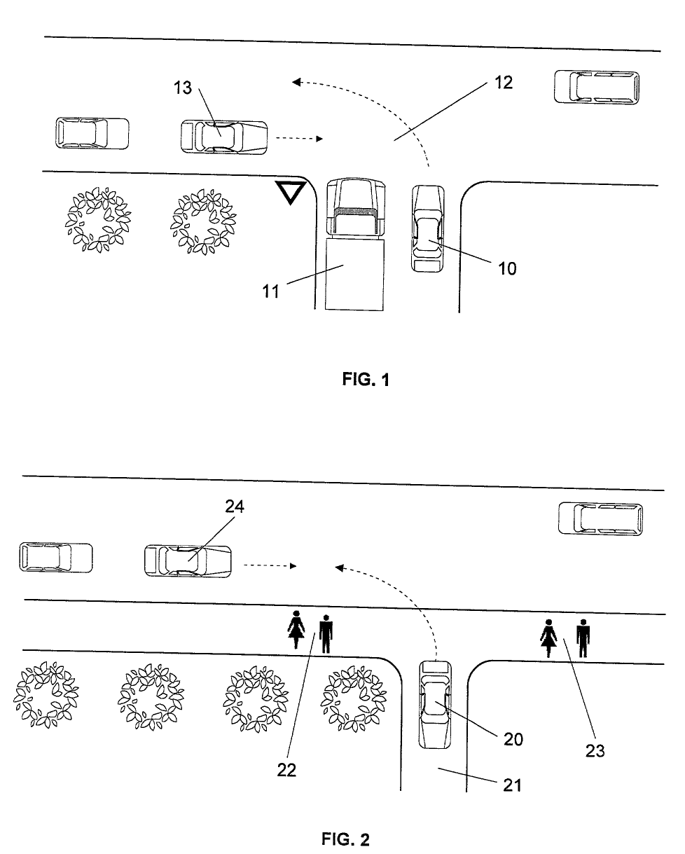

FIG. 4 shows schematically a mirror system according to the invention for improving a motorist's visibility;

FIG. 5 shows pictorially use of a mirror system installed toward the front end of a vehicle for improving a motorist's visibility when driving forward;

FIG. 6 shows pictorially use of a mirror system installed toward the rear end of a vehicle for improving a motorist's visibility when driving backwards;

FIGS. 7a, 7b and 8a, 8b, 8c show pictorially alternative configurations and locations of mirror systems according to the invention;

FIGS. 9 to 11 show schematically various mechanisms for elevating a mirror assembly of the mirror system out of a concealed housing when required;

FIG. 12 shows schematically an actuator for actuating the mechanisms illustrated in FIGS. 9 to 11;

FIGS. 13a and 13b show schematically in initial and final positions, respectively a rotation mechanism for rotating the mirror surface of a single mirror; and

FIGS. 14a and 14b show schematically in initial and final positions, respectively a rotation mechanism for rotating the respective mirror surfaces of a pair of mirrors.

### DETAILED DESCRIPTION OF THE INVENTION

In the following description of a mirror system for improving a motorist's visibility, like reference numerals will be used to refer to like components in different embodiments.

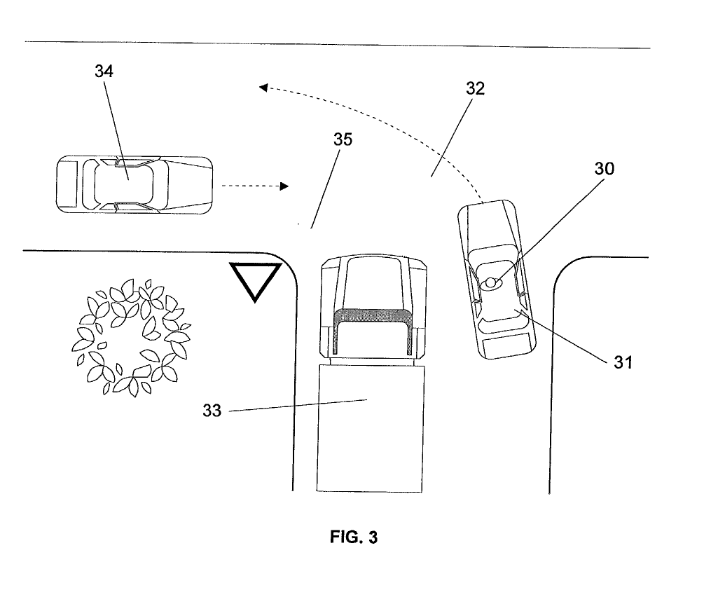

The usage of the mirror system assembly is demonstrated in FIGS. 4 to 6.

FIG. 4 shows, schematically, the ray tracing when using a mirror assembly according to the invention mounted on the left hand edge of a vehicle 40, and comprising a pair of mutually angular displaced mirrors 41 and 42 having convex reflecting surfaces providing panoramic field of view and rotatable about a hinge axis 43. An incident ray of light 44 is reflected from a vehicle (not shown) that approaches from the left of the vehicle 40 out of sight of a motorist 45 therein and is reflected by the mirror surface 41 as a ray of light 46 to the eyes of the motorist 45 enabling him to see in advance the oncoming vehicle. In a similar manner the mirror surface 42 enables the motorist 45 to see in advance an oncoming vehicle from the right side (not shown).

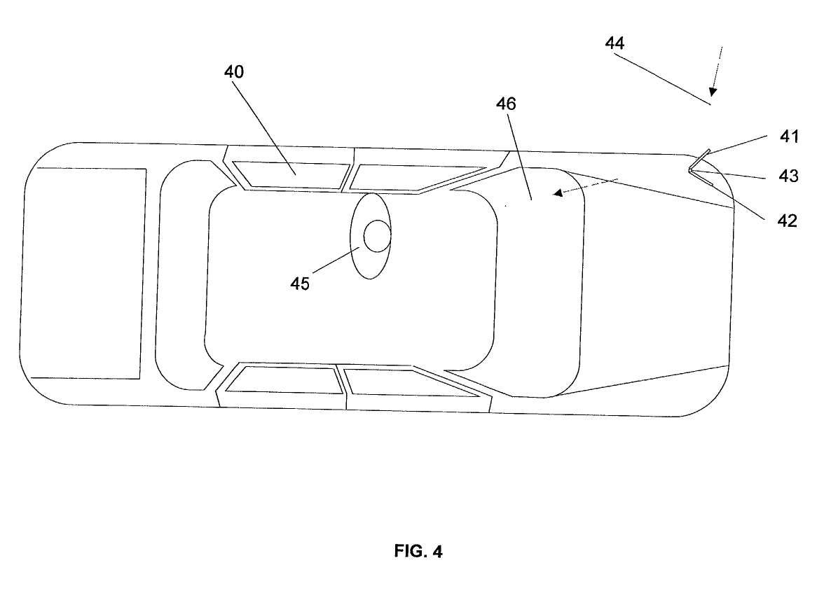

FIG. 5 shows the usage of such a mirror assembly in practice, when driving forward and demonstrates the ray tracing in such a case. A vehicle 50 attempts to pass a stationary vehicle 51 parked at the side of the road in order to turn left at a unction 52 into the path of an oncoming vehicle 53. However, in this case, the vehicle 50 is equipped with a mirror system designated generally as 54. An incident ray of light 55 is reflected from the oncoming vehicle 53 that is out of sight of a motorist 56 in the vehicle 50, through the mirror assembly 54 to the eyes of the motorist. In the arrangement shown in FIG. 5, the mirror system 54 is disposed toward a left hand edge of the vehicle. This arrangement is most suitable in countries where the Highway Code requires driving in the right lane. Clearly, in England and Australia and other countries where driving is permitted in the left lane, the opposite consideration will apply.

It has been assumed in the foregoing description of FIG. 5 that the mirror system 54 is disposed toward a front of the vehicle to protect against forward motion of the vehicle into a blind junction. However, it will readily be appreciated that the mirror system 54 can equally well be disposed toward a rear of the vehicle so as to afford protection to the motorist when reversing into a blind junction as shown pictorially in FIG. 2.

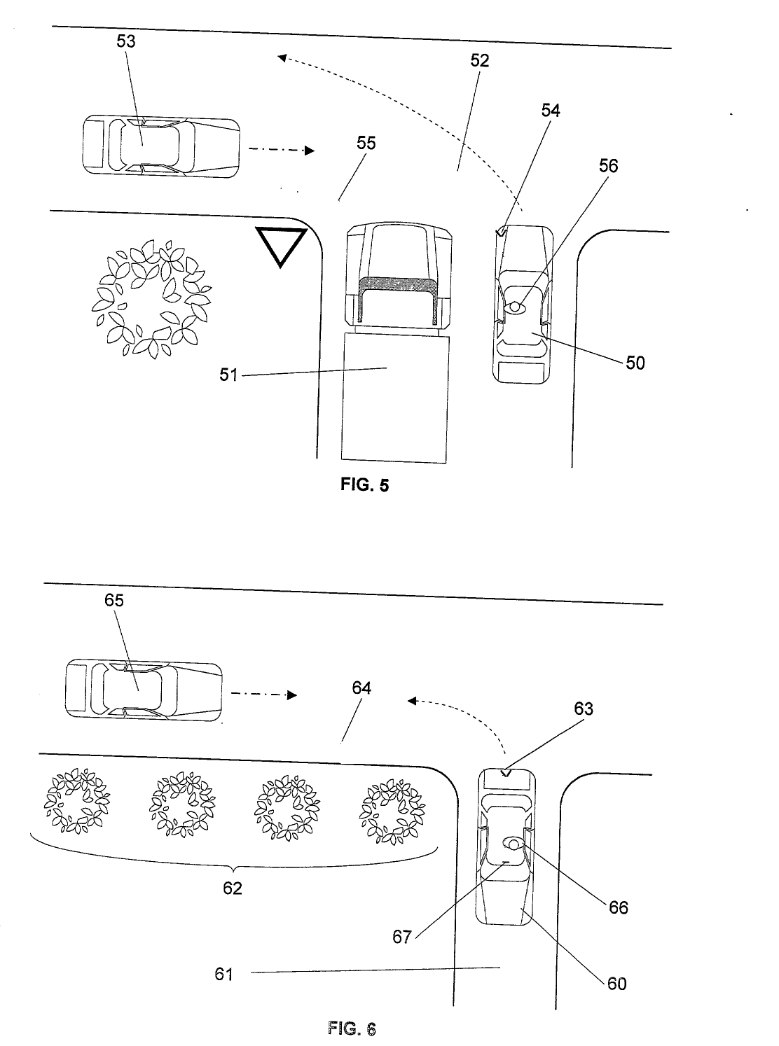

FIG. 6 shows the usage of such a mirror assembly in practice, when driving in reverse and demonstrates the ray tracing in such a case. A vehicle 60 is shown attempting to exit a parking lot 61 when driving in reverse, in this case the motorist's line of sight being partially occluded by trees 62 on his right hand side. A mirror system 63 is disposed mid-line at the rear of the vehicle 60. The principle of operation is similar to that described above with reference to FIG. 5 of the drawings, the main difference being that an incident beam 64 is reflected from the oncoming vehicle 65 that is out of sight of a motorist 66 in the vehicle 60, strikes the mirror assembly 63 and is reflected thereby to the rear view mirror 67 near the front windshield, from where it is reflected into the eyes of the motorist 66.

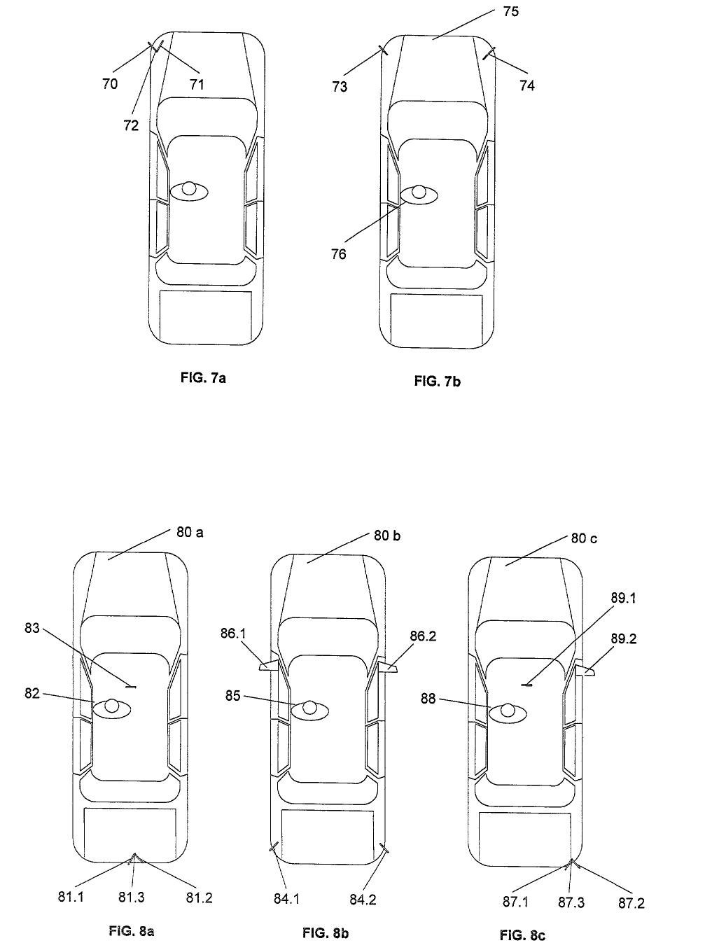

FIGS. 7a, 7b, 8a, 8b and 8c show pictorially alternative configurations and locations of mirror systems according to the invention. Thus, FIG. 7a shows a mirror assembly to include a pair of mutually angular displaced mirrors 70 and 71 that are rotatable about a hinge axis 72. FIG. 7b shows a mirror assembly, comprising separate left and right mirrors 73 and 74, respectively, which are independently supported so as to be rotatable about respective hinge axes (not shown) or about a common hinge axis. The left mirror 73 is disposed oblique to a left wing of the vehicle 75 so as to reflect an oblique light beam emanating from an oncoming vehicle (not shown) on the left side of the vehicle 75 into the line of sight of the motorist 76. The right mirror 74 is disposed oblique to a right wing of the vehicle so as to reflect an oblique light beam emanating from an oncoming vehicle (not shown) on the right side of the vehicle 75 into the line of sight of the motorist 76.

FIG. 8a shows a mirror arrangement disposed at the rear midline of the vehicle 80a, at the rear of the vehicle towards its right wing. The mirror arrangement includes a pair of mutually angularly displaced left and right mirrors 81.1 and 81.2, respectively, that are rotatable about a hinge axis 81.3. The left mirror 81.1 is disposed oblique to a left wing of the vehicle 80a so as to reflect an oblique light beam emanating from an oncoming vehicle (not shown) on the left into the line of sight of the motorist 82 via the rearview mirror 83. The right mirror 81.2 is disposed oblique to a right wing of the vehicle 80a so as to reflect an oblique light beam emanating from an oncoming vehicle (not shown) on the right into the line of sight of the motorist 82 via the rearview mirror 83.

FIG. 8b shows an arrangement comprising two separate left and right mirrors 84.1 and 84.2, respectively, which are independently supported so as to be rotatable about respective hinge axes (not shown) on respective left and right rear wings of the vehicle 80b. The left mirror 84.1 is disposed oblique to a left wing of the vehicle 80b so as to reflect an oblique light beam emanating from an oncoming vehicle (not shown) on the left side of the vehicle 80b into the line of sight of the motorist 85 via the left side view mirror 86.1. The right mirror 84.2 is disposed oblique to a right wing of the vehicle 80b so as to reflect an oblique light beam emanating from an oncoming vehicle (not shown) on the right into the line of sight of the motorist 85 via the right side view mirror 86.2.

FIG. 8c shows a mirror arrangement disposed at the right rear side of the vehicle, towards its right wing. The mirror arrangement includes a pair of mutually angularly displaced left and right mirrors 87.1 and 87.2, respectively, that are rotatable about a hinge axis 87.3. The left mirror 87.1 is disposed oblique to a right wing of the vehicle 80c so as to reflect an oblique light beam emanating from an oncoming vehicle (not shown) on the left into the line of sight of the motorist 88 via the rearview mirror 89.1 or, in cases where the motorist 88 turns his head to his right side, by looking directly into the mirror 87.1. The right mirror 87.2 is disposed oblique to a right wing of the vehicle 80c so as to reflect an oblique light beam emanating from an oncoming vehicle (not shown) on the right into the line of sight of the motorist 88 via the rearview mirror 89.2.

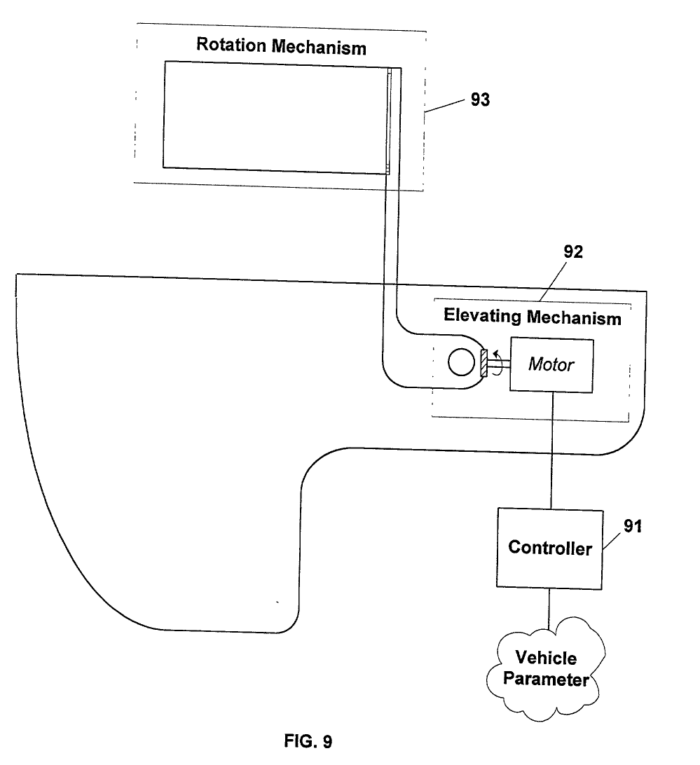

Having described the invention schematically, reference is now made to FIG. 9 showing a block diagram of the various systems involved in the process. The mirror assembly is raised and lowered under control of a controller 91 operatively coupled to an elevation mechanism 92. A rotation mechanism 93 is coupled to the mirror assembly for rotating the reflecting surface(s) of the mirror(s) thereof after extraction by the elevation mechanism 92. The mirror assembly is raised upon the motorist's request providing that preset vehicle derived parameters (such as vehicle velocity, the gear position etc.) comply with preset conditions. When these preset conditions are met, a signal is transmitted from the controller 91 to the elevating mechanism 92. After the successful elevation of the mirror assembly, the mirror(s) are then rotated to the final position by the rotation mechanism 93.

The controller 91 may be responsive to a speed of the vehicle for retracting the at least one mirror back into the housing if the speed exceeds a predetermined threshold. Additionally or alternatively, the controller may be responsive to a distance traveled by the vehicle for collapsing the at least one mirror back into the housing if the distance exceeds a predetermined threshold. By such means, the mechanism is adapted to collapse the mirror or mirrors back into the housing automatically after use, since it may be assumed that after the vehicle has traveled more than the preset distance or has increased speed beyond the preset limit, the motorist has completed his maneuver and the mirror assembly may safely be retracted.

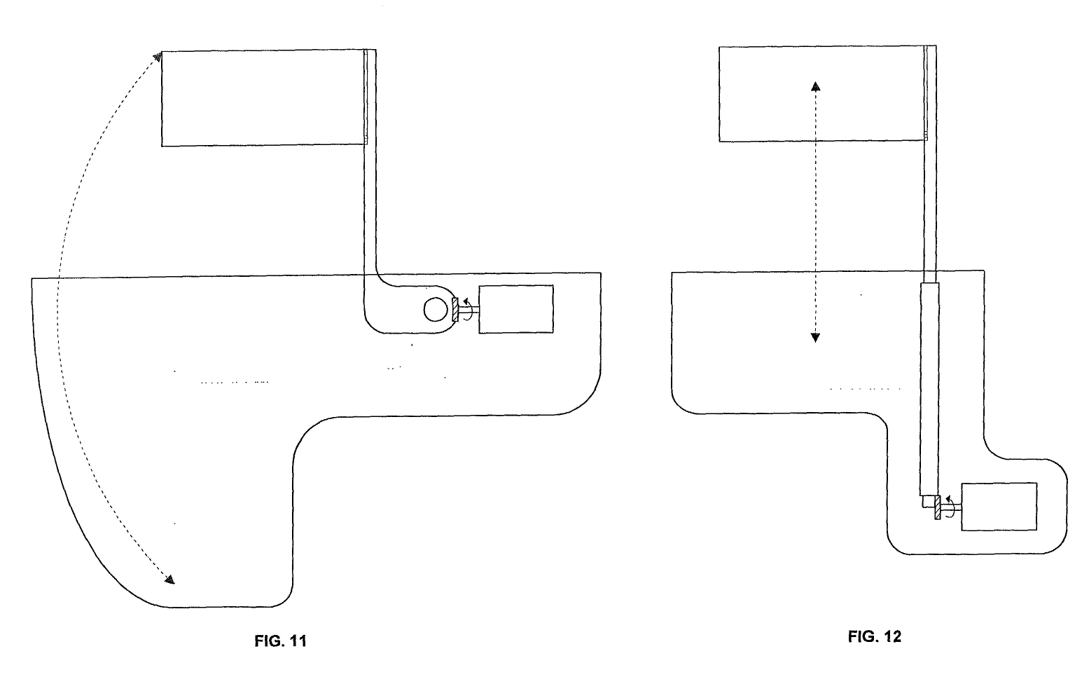

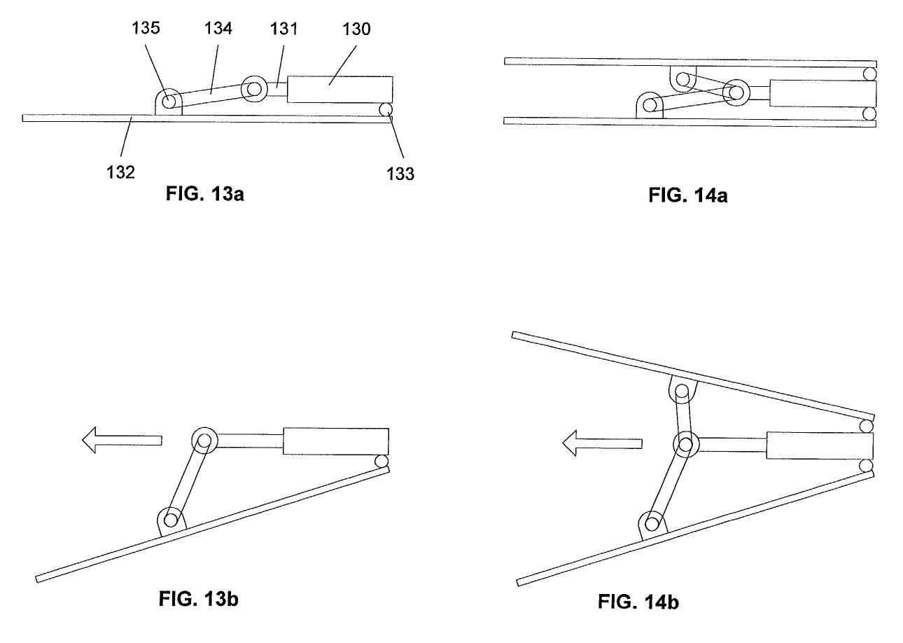

FIGS. 10 to 12 show schematically various elevating mechanisms, FIGS. 13a and 13b and FIGS. 14a and 14b show schematically a rotating mechanism.

FIG. 10 shows schematically a housing 100 capable of being mounted beneath an exterior surface of a vehicle (not shown). The housing 100 contains a motor 101 having a shaft 102 rotatably coupled to a mirror support 103 supporting a mirror 104. Rotation of the motor shaft 101 causes the mirror support 103 and with it the mirror 104 to be rotated about an axis 105 normal to the drawing plane from an inoperative position 104.1 where it is contained fully within the housing 100, to an operative position 104.2 where it is elevated out of the housing 100. An upper surface of the housing is provided with a rotatable or otherwise displaceable flap (not shown) contoured to match the contour of the upper surface of the vehicle so that when the housing 100 is mounted in places such as the engine compartment of a vehicle, the flap is flush with the upper surface of the vehicle. Elevation of the mirror assembly causes the flap to withdraw thereby allowing unimpeded elevation of the mirror assembly and after subsequent retraction of the mirror assembly back into the housing, the flap closes flush within the upper surface of the vehicle.

FIG. 11 shows schematically an alternative mechanism wherein the mirror is supported by an L-shaped support bracket that is rotatably coupled to the motor so that when the support bracket is rotated about an axis normal to the plane of the drawing and orthogonal to the motor shaft, the mirror assembly is elevated from or retracted into the housing.

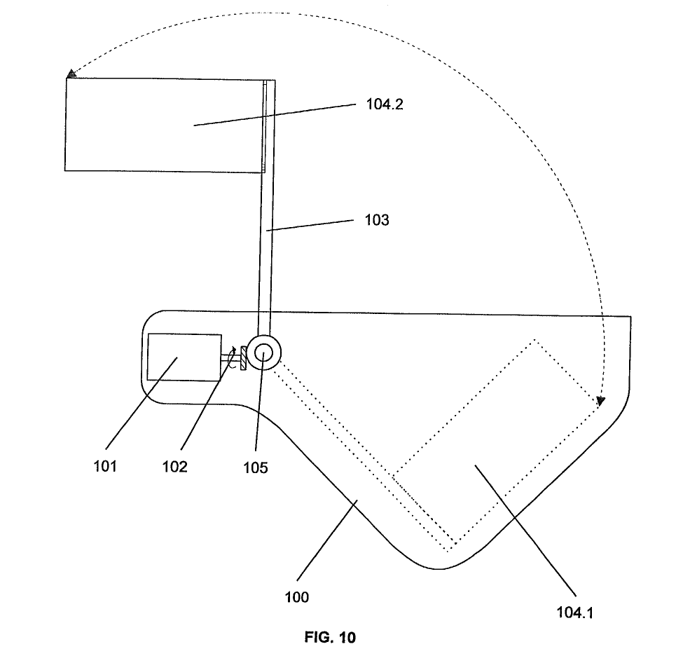

FIG. 12 shows an alternative mirror assembly using a telescopic element instead of the rotating one for elevating and retracting the mirror assembly.

In all the mechanisms shown schematically in FIGS. 9, 10, 11 and 12, the mirror support may be adapted to collapse on impact so that in the event of collision with a pedestrian minimal damage is caused to the pedestrian.

After the mirror assembly is elevated, a rotation mechanism shown in FIGS. 13a, 13b, 14a and 14b is operated for rotating the mirror surface to its final position. FIGS. 13a and 13b relate to a single mirror assembly as described above with reference to FIG. 7b.

FIG. 13a shows a telescopic motor 130 having a piston 131 in its retracted position and being pivotably attached to a rear surface of a mirror 132 at a first hinge joint 133. The piston 130 is rotatably coupled to a rigid connection rod 134 that is pivotably attached to the rear surface of the mirror at a second hinge joint 135. When the mirror assembly is fully elevated, the controller sends a signal to the motor 130 causing the motor to extract the piston 131 and by so doing, swinging the mirror surface about the axis of joint 133 to an end position shown in FIG. 13b.

FIGS. 14a and 14b show respectively initial and end positions of a dual mechanism operating according to the same principle for rotating a pair of mutual displaceable mirrors simultaneously. It will be understood that the rotating mechanism may be actuated even before fully elevating the mirror assembly, i.e. after passing through the exterior surface of the vehicle.

As noted above all three embodiments shown in FIGS. 10 to 12, in order that the mirror system may be completely concealed when not in actual use, the housings are provided with a top cover or flap that may be closed flush with an exterior surface of the vehicle's body. The manner in which this is accomplished is known in the art and is described, for example, in U.S. Pat. No. 6,152,385 (Walter Nube et al.) entitled “Covering device for an opening in the outer shell of a motor vehicle”, the contents of which are incorporated herein by reference.

It will be understood that the description of the mechanism and its method of actuation are schematic since many different and equally suitable approaches will readily by apparent to those skilled in the art. Thus, for example, if desired, a mechanical coupling can be employed to open the cover plate and lift the mirror assembly out of the housing. Such a mechanical coupling can be operated via a foot pedal or other suitable lever.

It will likewise be apparent that other modifications will be apparent to those skilled in the art without departing from the scope of the invention as defined by the claims. Thus, different locations for mounting the mirror assembly are possible apart from those shown in the figures, which are for illustration only.

It is envisaged that the mirror system according to the invention will be mounted in the vehicle as an auxiliary built-in feature during manufacture of the vehicle. However, the invention is also intended to cover the possibility that the vehicle's owner install the mirror system. Thus, external unconcealed installation is clearly within the province of a competent owner without requiring special skills. Likewise, in order to facilitate concealed installation under the hood of the vehicle, for example, manufacturers may provide clearance under the hood to accommodate the mirror system and may provide a flush, displaceable cover for concealing the mirror assembly if installed. In such case, the vehicle's owner or any other suitable third party may sell the mirror system as a retrofit item for installment.

1. A mirror system for improving a motorist's field of vision, said mirror system comprising:
at least one mirror having a convex reflecting surface,
a housing capable of being mounted beneath an exterior surface of a vehicle for accommodating therein said at least one mirror when not in use, and
a mechanism for elevating the at least one mirror out of the housing through an opening in the exterior surface of the vehicle and for rotating the at least one mirror after its elevation through said opening into a line of sight of the motorist thus allowing a cross-section of the opening to have a smaller area than a cross-section of the at least one mirror.

2. The mirror system according to claim 1, including first and second foldable mirrors that are accommodated within the housing when not in use, said mechanism being adapted to elevate said mirrors out of the housing and to rotate the first mirror relative to the second mirror so that both mirrors are visible by the motorist and provide an additional field of view on opposite sides of the vehicle.

3. The mirror system according to claim 1, wherein the mechanism is adapted to collapse the at least one mirror back into the housing automatically.

4. The mirror system according to claim 1, wherein the mechanism is adapted to collapse the at least one mirror back into the housing automatically.

5. The mirror system according to claim 3, wherein the mechanism includes a controller responsive to at least one parameter associated with the vehicle for retracting the at least one mirror back into the housing.

6. The mirror system according to claim 4, wherein the mechanism includes a controller responsive to at least one parameter associated with the vehicle for retracting the at least one mirror back into the housing.

7. The mirror system according to claim 1, wherein the at least one mirror is mounted on a support that collapses upon impact.

8. The mirror system according to claim 1, wherein the mechanism includes an elevation mechanism that is adapted to rotate the at least one mirror out of the housing.

9. The mirror system according to claim 1, wherein the mechanism includes a telescopic elevation mechanism that is adapted to raise and lower the at least one mirror out of and into the housing telescopically.

10. The mirror system according to claim 1, wherein the mechanism includes a rotation mechanism that includes a telescopic motor having a piston pivotably attached to a rear surface of the at least one mirror so as to rotate the mirror when said piston is extracted and retracted.

11. The mirror system according to claim 2, wherein the mechanism includes a rotation mechanism that includes a telescopic motor having a piston pivotably attached to a rear surface of each of said mirrors so as to rotate the mirrors simultaneously when said piston is extracted and retracted.

12. The mirror system according to claim 1, wherein the housing is provided with a displaceable cover that is adapted to be closed flush with the exterior surface of the vehicle when not in use.

13. The mirror system according to claim 2, wherein the housing is provided with a displaceable cover that is adapted to be closed flush with the exterior surface of the vehicle when not in use.
